(19) United States
(12) Patent Application Publication
(10) Pub. No.: US 2004/0018016 A1
(43) Pub. Date: Jan. 29, 2004

(54) Optical transport networks

(76) Inventors: Michael O'Mahony, Suffolk (GB); Dimitra Simeonidou, Essex (GB)

Correspondence Address: NIXON & VANDERHYE, PC, 1100 N GLEBE ROAD, 8TH FLOOR, ARLINGTON, VA, 22201-4714, US

(21) Appl. No.: 10/275,917

(22) PCT Filed: May 11, 2001
(86) PCT No.: PCT/GB01/02087

(30) Foreign Application Priority Data
May 11, 2000 (GB) 0011412.4
May 11, 2000 (GB) 0011413.2
Sep. 21, 2000 (GB) 0023222.3
Sep. 21, 2000 (GB) 0023217.3

(51) Int. Cl. H04J 14/00

(52) U.S. Cl. 398/43

(57) ABSTRACT

The present invention provides an optical packet switch (3, 4) that facilitates efficient provisioning of packet services through a predominantly circuit-switched optical transport network infrastructure (1). In particular, the optical packet switch (3, 4) fits within a network where circuit and packet-switched traffic are transported together through the optical transport network (1). Fast switching is provided for packet traffic where granularity below the wavelength level is required, while slow wavelength switching and routing is facilitated at the same time. Fast switching and packet traffic aggregation for efficient bandwidth utilisation is performed at the edge where the optical transport network (1) interfaces with the IP domain (6), where dynamic and fast wavelength allocation for packet traffic is required.

### BACKGROUND TO THE INVENTION

Telecommunications networks are experiencing a massive increase in the demand for capacity, particularly in relation to Internet traffic. To support this demand economically, optical networks are evolving which include a dynamically reconfigurable optical transport layer, based on fast optical cross-connects (OXCs) coupled with a suitable control and management architecture. In the near future it is expected that an optical transport network (OTN) will be realised capable of supporting large numbers of high capacity optical channels (OChs), with bit rates of 10-40 Gb/s.

In this projected future scenario, it might seem that bandwidth will not be an issue. However, the ever increasing traffic and economic considerations will demand that network resources are used as efficiently as possible. Pure optical packet switching in which packet headers are read optically has been difficult to achieve. Current OXCs support continuous data streams and are not fast enough to support packet-by-packet switching. Therefore the entire traffic on any OCh at an input port in an OXC is switched to one output port. This is an undesirable as IP traffic, for example, cannot be constructed as a continuous data stream. Since the OTN only supports continuous data streams, it offers granularity only at the wavelength level. Thus if the channel traffic is bursty the channel capacity may be underused, which has an impact on the dimensioning of the network and the size of the OXCs required.

### SUMMARY OF THE INVENTION

According to a first aspect of the present invention, there is provided a communications network, comprising:

a packet switched electronic network;

a wavelength switched optical network; and,

an optical routing node at an interface between the electronic network and the optical network for aggregating a plurality of packets from the electronic network into an optical packet for transmission across the optical network on one of a number of wavelengths.

According to a second aspect of the present invention, there is provided a method of transporting optical packet traffic in a wavelength switched optical network comprising the steps of aggregating packets received at the edge of a packet switched electronic network into optical packets, mapping the optical packets onto one of a number of wavelengths that determine the route of the optical packets, and transmitting the optical packet onto the wavelength switched optical network.

Preferably, the optical routing node comprises an optical packet switch (OPS). Preferably, the optical routing node includes an optical cross connect (OXC) coupled to the OPS. Preferably, the OPS is connected to dedicated ports of an OXC such that specific wavelengths are reserved for optical packet traffic.

The wavelength switched optical network is associated with a network control plane, preferably based on distributed Multiple Protocol Label Switching (MPLS), and having an associated MPλS control plane. The functions of the MPλS control plane are to determine, distribute and maintain state information associated with the optical network, and to establish and maintain optical channel trails within the network. The MPλS control plane is also responsible for updating information in local switch controllers.

In hybrid communications networks including an electronic network and an optical network, a uniform control strategy is needed.

According to a third aspect of the present invention, there is provided a communications network, comprising:

a packet switched electronic network having a first control plane;

a wavelength switched optical network having a second control plane; and,

an optical routing node at an interface between the electronic network and the optical network that provides an interface between the first control plane and the second control plane for routing traffic as optical packets across the optical network.

Preferably, the optical routing node implements a third control plane that provides an interface between the first control plane and the second control plane to allow traffic to be routed between the electronic network and the optical network.

Preferably, the first control plane is an MPLS control plane. Preferably, the second control plane is an MPλS control plane.

There are several advantages in keeping the first and second control planes separate. There are a number of important differences between electronic data routers and optical wavelength routers that necessitate special features to be implemented in each control plane. The first difference is the bandwidth granularity, which is much coarser for an OXC than for an IP router. The high bandwidth nature of optical connections leads to the expectation that they will persist for longer and will involve relatively infrequent connection requests when compared to per packet routing operations. A further specific requirement for the optical network control plane is for it to maintain optical transport network (OTN) infrastructure information in order to facilitate path selection for optical channels. This information includes fibre characteristics, amplifier positions and signal evaluation data.

Another important reason for keeping the control planes separate is that they are likely to be under different administrative controls and policies. In these circumstances the service provider who owns the OTN wants to maintain full control of the network and does not want to give a client insight into the structure of the OTN as it is of business value.

Although the service provider does not wish to give clients knowledge of the OTN, there are client services that depend on having a view of the internal structure of the OTN. Three examples are given below. The first involves connections diversely routed for provisioning and restoration purposes. The second involves a connection required at a future time, while the third involves being able to know which label switched routers (LSRs) can be reached via the OTN. Thus the network management must allow limited internal OTN information to be accessed or manipulated by the client service layer in a manner that does not compromise the security of the operator's network. There are currently no router solutions that satisfy the above required functionality and which fit into a realistic future network solution.

Preferably, the optical routing mode comprises an optical packet switch (OPS). The OPS has an electronic controller which receives information from both the first and second control planes. The OPS and external electronic routers handle the same granularity (per packet) which leads to an integrated control plane between the electronic and wavelength switched networks. At the same time the OPS will maintain information on the configuration, the physical infrastructure, the topology and the scale of the OXC transport. Thus the OPS is able to isolate the OTN from the service layer while interfacing fully with both layers.

According to a fourth aspect of the present invention, there is provided an optical packet switch (OPS) for use within a wavelength division multiplexed (WDM) optical wavelength switched network comprising means for processing optical packets to provide packet level connectivity within the optical network.

Preferably, the OPS transmits packet traffic over one or more wavelengths supported by the optical network which are dedicated for optical packet traffic.

According to a fifth aspect of the present invention, there is provided a communications network comprising an optical packet switch according to the fourth aspect of the present invention provided at an interface between an electronic packet switched network and an optical wavelength switched network.

Preferably, the optical packet switch implements a control plane that provides an interface between a first control plane associated with the electronic network and a second control plane associated with the optical network to allow packet traffic to be routed between the electronic network and the optical network in a transparent manner.

According to a sixth aspect of the present invention, there is provided an optical router comprising an optical packet switch coupled to a number of dedicated ports of an optical cross-connect so that optical packet traffic can be routed on one of a number of dedicated wavelengths supported by the optical cross-connect.

### BRIEF DESCRIPTION OF THE DRAWINGS

An example of the present invention will now be described in detail with reference to the accompanying drawings, in which:

FIG. 1 is a schematic diagram of a communications network embodying the present invention;

FIG. 2 is a schematic diagram showing the logical interfacing between the network control planes;

FIG. 3 is a schematic diagram showing the functionality of an optical packet switch used in the network of FIG. 1;

FIG. 4 is a schematic diagram showing the interfacing of an OPS with an OXC according to an example of the present invention; and,

FIG. 5 is a schematic diagram of an optical packet switch.

### DETAILED DESCRIPTION

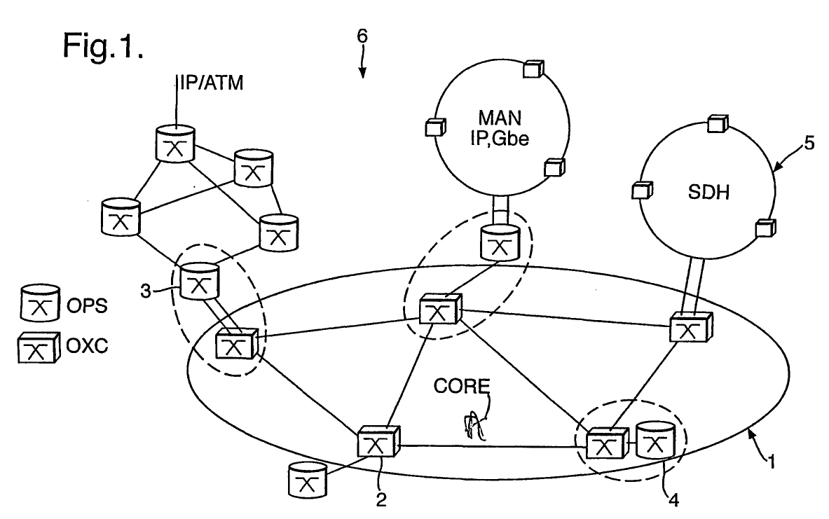

FIG. 1 illustrates a network 1 including a number of optical cross connect (OXC) 2 and optical packet switch (OPS) 3,4 elements. As shown, resources can be used in a number of ways. For example, some optical channels (wavelength paths) may interconnect high-capacity points that will fully utilize channel capacity, such as SDH rings 5. Other channels might be used to support optical packet transmission for efficient use of bandwidth, to either optimize resource utilization within the network or, for example, support an end-to-end point and click provisioning service where granularity may be an issue. FIG. 1 therefore illustrates two key OPS application scenarios: One is the application as a core switch. Optical packets travelling through the network undergo switching at core nodes where ongoing route selection and label swapping take place. In this mode the OPSs 4 maximize utilization of the network resources, minimizing the total network capacity required, and reducing the size of the OXCs. The second application is that of an edge router interfacing the electronic IP domain to the optical transport network (OTN) 1. Thus is illustrated in FIG. 1, which shows the OPS 3 positioned as an edge router interfacing to both the OTN and IP domains. In this application the OPS 3 provides a number of key functions required of the future OTN, as will be discussed below.

In the present invention provides an OPS that facilitates efficient provisioning of packet services through a predominantly circuit-switched OTN infrastructure. The OPSs will fit in a network where circuit and packet-switched traffic are transported together through the OTN. The optical packet switching functionality will then coexist with wavelength routing provided through the OXCs. In this case, fast switching will be provided for the packet traffic where granularity below the wavelength level is required, while slow wavelength switching and routing will be facilitated at the same time. Fast switching and packet traffic aggregation for efficient bandwidth utilization is performed at the edge of the network (the interface with the IP domain) where dynamic and fast wavelength allocation for packet traffic will be required. In this implementation the OPS router 3 is an edge network device, which functions as a topological and logical interface between the service and transport layers. The OPS router 3 can directly interface with the OXC which makes a set of static wavelength and fiber routes available to the OPS traffic. In particular, the OXC provides a central switch fabric capable of interconnecting demultiplexed input wavelength channels to the appropriate outgoing fibres. The OPS is positioned in the add-drop ports of the OXC and accesses wavelength channels dedicated to packet switching. Interconnection is controlled through management and control subsystems.

In the present invention, external electronic routers and OPSs handle the same granularity (per packet), which will lead to an integrated control plane between the IP and the OTN domains. At the same time, each OPS maintains information on the configuration, the physcial infrastructure, the topology and scale of the OXC transport. Th refore, the OPS of the present invention is able to isolate the OTN from the service layer while interfacing fully with both layers, ie with the data/IP domain through integrated management control, and with the OTN by maintaining information on the configuration, the physical infrastructure, the topology and scale of the OXC transport.

An additional benefit of the OPS is due to the increased granularity over pure DWDM networks, which permits more efficient use to be made of the core network. One of the main disadvantages of an OTN is that there is currently no mechanism to provide direct access to the OTN with bandwidth granularity that is finer than a whole wavelength. Providing this finer granularity is central to creating a network that is efficient, from the perspective of the operator, and cost effective, for the operators customer.

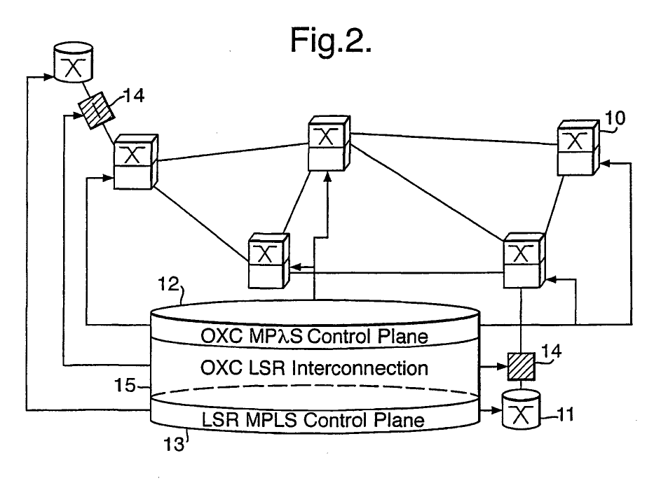

FIG. 2 shows an optical network comprising a plurality of interconnected OXCs 10. Also shown are a number of Label Switching Routers (LSRs) 11 which switch packets in an electronic IP network. The OXCs 10 are controlled by an MPλS network control plane 12. The functions of this control plane 12 are to determine, distribute, and maintain state information associated with the OTN and to establish and maintain optical channel trails within the network. This control plane is also responsible for updating the information in each local switch controller. The OXCs 10 within the OTN switch optical channels in a similar way to LSRs switch packets in an electronic IP network. LSRs perform packet level operations using information carried on the labels attached to the data packets, while the OXCs switch on the basis of wavelength. The electronic network is controlled by a Multiprotocol Label Switching (MPLS) 13 control plane.

The control planes for the OXCs 10 and LSRs 11 are kept separate for reasons which have been explained above. The interfacing between the control planes 12,13 is achieved with the use of an OPS 14 in accordance with the present invention that provides an intermediate control plane 15, termed Optical Multiprotocol Label Switching (OMPLS), which receives information from both the MPLS control plane and the MPλS control plane.

The LSRs 11 and the OPSs 10 handle the same granularity (per packet) which leads to an integrated control plane between the IP and wavelength switched networks. At the same time the OPS will maintain information on the configuration, the physical infrastructure, the topology and the scale of the OXC transport Thus the OPS is able to isolate the OTN from the service layer while interfacing fully with both layers.

OPSs of the type described can also be used in the core of the OTN as intermediary nodes. The OPSs are still connected to dedicated add/drop ports of OXCs however they do not need to receive control information directly from the MPLS control plane.

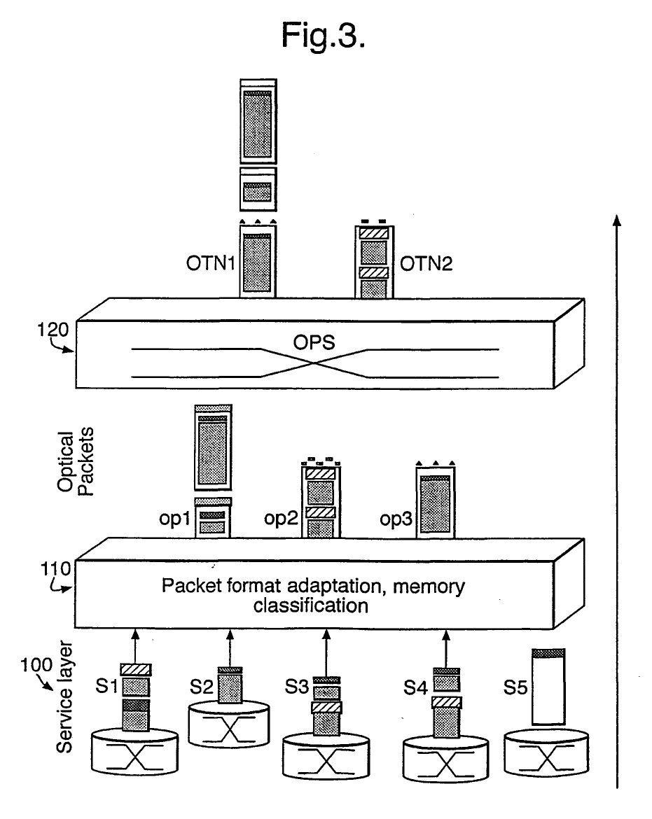

A schematic representation of the various stages in the operation of an OPS as an edge aggregator/router is shown in FIG. 3. In a first step 100 the OPS accepts packet type traffic from the service layer, i.e. IP and ATM traffic, from a number of sources. These packets are associated with the MPLS control plane. The multiple sources are signified by different header shadings in FIG. 3. In the next step 110 the input packets are aggregated based on destination and Quality of Service (QoS) parameters, and are formed into optical packets with OMPLS labels that signify destination and QoS class. These OMPLS labels are generated locally by an OMPLS control plane that functions as an intermediate control plane between the MPLS control plane associated with the IP domain and the MpλS control plane associated with the OTN. FIG. 3 shows optical packets with two destinations with two QoS classes, giving three different label values. The optical packets are of variable length but all are an integer multiple of a chosen time unit. In a final step 120, the optical packets are switched to an appropriate wavelength channel and a new label is written into the optical packet so that it is compatible with the MpλS control plane of the OTN. The optical packets are then routed over the OTN on particular wavelengths to deaggregating nodes that are egress points from the OTN or to intermediary nodes that further map the optical packets onto new wavelength paths. Contention resolution is based on QoS class implied from the label on the optical packets. During the whole process the OPS runs a protocol capable of discovering the OXC network topology, and thus is able to combine aggregation with QoS provisioning within the OTN.

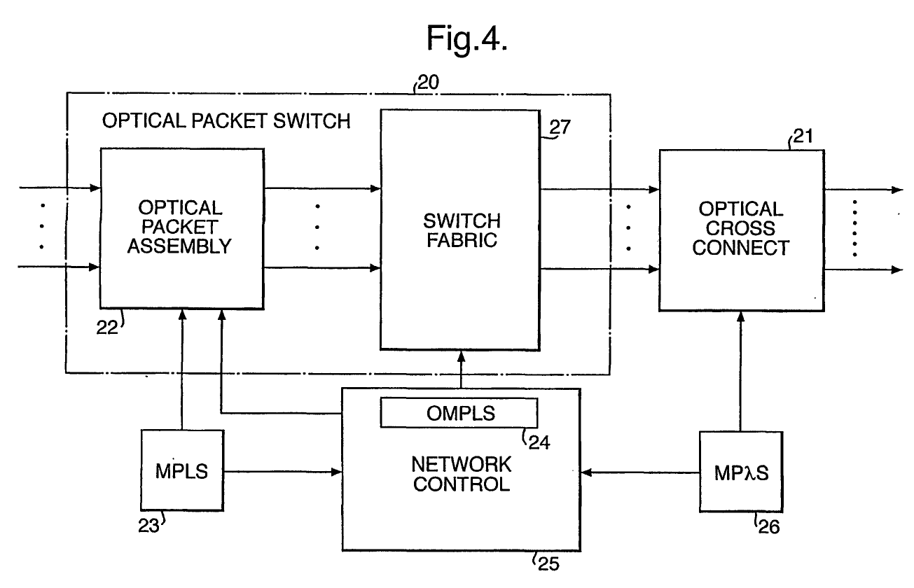

FIG. 4 shows an example of an optical routing node in which an OPS 20 directly interfaces with an OXC 21. A preferred OXC is described in our co-pending International patent application PCT/GB01/01370.

Incoming IP packet traffic, which is in optical or electronic form, enters an optical packet assembler 22. The optical packet assembler 22 converts the IP packets into optical packets. This involves converting electrical signals into optical signals followed by aggregation of a number of packets into a single optical packet. The header of each IP packet contains destination and QoS information and is read electronically. The aggregation is performed on the basis of that information and a label is attached to each optical packet. As shown, the optical packet assembler is controlled by the MPLS control plane 23 and the OMPLS control plane 24 which is located within a network control 25 which receives and processes information from both the electronic network MPLS control plane 23 and the optical network MPλS control plane 26. The OPS 20 also comprises a switch fabric 27 which is coupled to dedicated add-drop ports of the OXC 21 and accesses wavelength channels dedicated to packet traffic. The OPS 20 switch fabric 27 switches the optical packets onto an appropriate wavelength. The OPS is controlled by the OMPLS control plane 24. The OXC 21 has a switch fabric capable of interconnecting demultiplexed input wavelength channels to appropriate outgoing fibres. These interconnections are controlled through management and node control systems which are connected to the MPλS control plane 26.

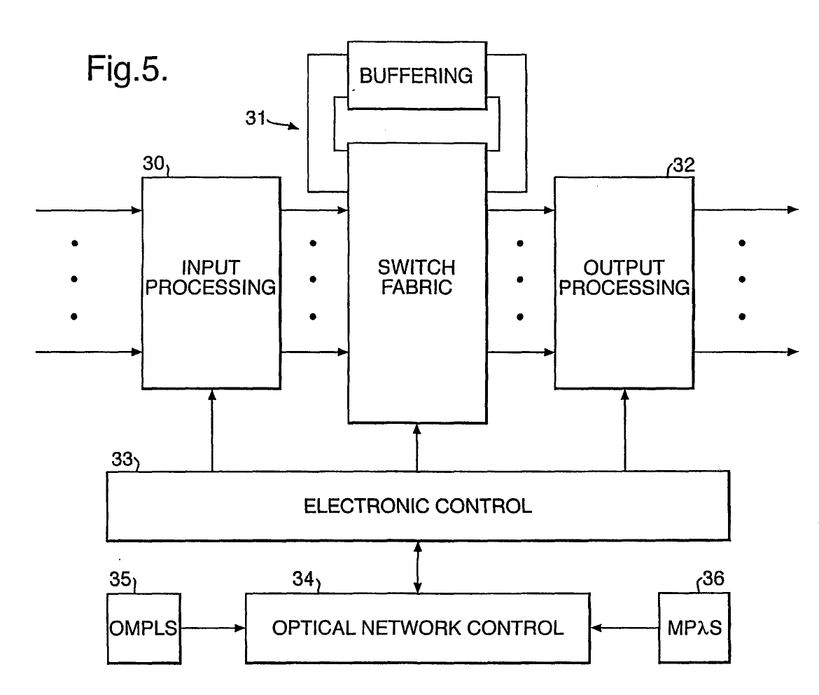

FIG. 5 shows a generic structure of an optical packet switch suitable for use in the present invention. The OPS consists of an input processing interface 30, a switching and buffering block 31, and an output processing module 32, all controlled by an electronic control 33. The input interface 30 performs delineation (i.e. identification of the packet start and end), packet format adaptation into the optical packet, classification into forward equivalent classes defined for the OTN, and electronic buffering. The switching and buffering blocks 31 are responsible for routing of the optical packets to the appropriate output ports and contention resolution respectively, while the output interface 32 is responsible for header reinsertion and per packet conditioning such as wavelength conversion to the appropriate OTN wavelengths, regeneration and power equalisation. The architecture is based on a feedback buffering scheme to enable preemption and maximum utilisation and sharing of the available buffers. The switch and electronic control 33 are controlled by an optical network control 34 which exchanges information with both the OMPLS 35 and MPλS 36 control planes.

Packet-by-packet switching can be performed using a switch matrix based on semiconductor optical amplifier (SOA) gates or opto-electronic technology. However, in this example the switch matrix is based on tuneable wavelength converters followed by wavelength routing device such as an arrayed waveguide grating (AWG). In this case, routing of the switch is performed by controlling the wavelength of the incoming packets through the input conversion stage and subsequent transmission through the AWG. Optical wavelength conversion is performed through SOA-based converters using either cross-gain modulation or cross-phase modulation t chniques.

Buffering functionality is provided through a combination of electronic and optical buffering. Optics is used for very short delays which form the vast majority of storage, and electronics is used for longer delays. The amount of electronic memory, with its costly electrical to optical and optical to electrical interfaces, is thus reduced. The wavelength agility offered using wavelength conversion on a per packet basis enables statistical multiplexing at the fibre bandwidth capacity level. Tuneable wavelength converters significantly reduce the buffering requirements by appropriately wavelength translating optical packets so that they can be transmitted in parallel within the same delay line.

1. A communications network, comprising:
a packet switched electronic network;
a wavelength switched optical network; and
an optical routing node at an interface between the electronic network and the optical network for aggregating a plurality of packets from the electronic network into an optical packet for transmission across the optical network on one of a number of wavelengths.

2. A communications network according to claim 1, wherein the optical routing node comprises an optical packet switch (OPS).

3. A communications network according to claim 2, wherein the optical routing node includes an optical cross connect (OXC) coupled to the OPS.

4. A communications network according to claim 2 or 3, wherein the OPS is connected to dedicated ports of an OXC such that specific wavelengths are reserved for optical packet traffic.

5. A method of transporting optical packet traffic in a wavelength switched optical network comprising the steps of:
aggregating packets received at the edge of a packet switched electronic network into optical packets;
mapping the optical packets onto one of a number of wavelengths that determine the route of the optical packets; and,
transmitting the optical packet onto the wavelength switched optical network.

6. A communications network, comprising:
a packet switched electronic network having a first control plane;
a wavelength switched optical network having a second control plane; and,
an optical routing node at an interface between the electronic network and the optical network that provides an interface between the first control plane and the second control plane for routing traffic as optical packets across the optical network.

7. A communications network according to claim 6, wherein the optical routing node implements a third control plane that provides an interface between the first control plane and the second control plane to allow traffic to be routed between the electronic network and the optical network.

8. A communications network according to claim 6 or 7, wherein the first control plane is an MPLS control plane.

9. A communications network according to any one of claims 6 to 8, wherein the second control plane Is an MPλS control plane.

10. A communications network according to any one of claims 6 to 9, wherein the optical routing mode comprises an optical packet switch (OPS), which has an electronic controller which receives information from both the first and second control planes.

11. An optical packet switch (OPS) for use within a wavelength division multiplexed (WDM) optical wavelength switched network comprising means for processing optical packets to provide packet level connectivity within the optical network.

12. An optical packet switch according to claim 10, wherein OPS transmits packet traffic over one or more wavelengths supported by the optical network which are dedicated for optical packet traffic.

13. A communications network comprising an optical packet switch according to claim 11 or 12 provided at an interface between an electronic packet switched network and an optical wavelength switched network.

14. A communications network according to claim 12, wherein the optical packet switch implements a control plane that provides an interface between a first control plane associated with the electronic network and a second control plane associated with the optical network to allow packet traffic to be routed between the electronic network and the optical network in a transparent manner.

15. An optical router comprising an optical packet switch coupled to a numb r of dedicated ports of an optical cross-connect so that optical packet traffic can be routed on one of a number of dedicated wavelengths supported by the optical cross-connect.
